(19) United States
(12) Patent Application Publication
(10) Pub. No.: US 2013/0322006 A1
(43) Pub. Date: Dec. 5, 2013

(54) COMPUTER ENCLOSURE AND MOUNTING ASSEMBLY FOR DATA STORAGE DEVICE OF THE SAME

(71) Applicant: ZHENG-HENG SUN, Tu-Cheng (TW)

(72) Inventor: ZHENG-HENG SUN, Tu-Cheng (TW)

(73) Assignee: HON HAI PRECISION INDUSTRY CO., LTD., Tu-Cheng (TW)

(21) Appl. No.: 13/525,385

(22) Filed: Jun. 18, 2012

(30) Foreign Application Priority Data
Jun. 5, 2012 (CN) 201210181913.9

(51) Int. Cl. G06F 1/16

(52) U.S. Cl. 361/679.31

(57) ABSTRACT

A fixing assembly for mounting a data storage device includes a fixing piece mounted to a sidewall of a computer enclosure, and a casing for receiving the data storage device. The casing includes a top wall, a bottom wall, two end walls, and a rear wall. The casing defines an opening in a front side of the casing opposite to the rear wall, through which the data storage device enters the casing. One of the end walls of the casing is fixed to the fixing piece. A blocking piece extends out from the other end wall. A projection protrudes from an inner surface of the blocking piece to block an outer side of the data storage device opposite to the rear wall. A dummy connector extends out from the rear wall to be inserted into a socket formed on a motherboard received in the computer enclosure.

### BACKGROUND

1. Technical Field

The present disclosure relates to a computer enclosure having a mounting assembly for installing a data storage device.

2. Description of Related Art

Conventional computer motherboards may include a plurality of peripheral component interconnect (PCI) sockets for mounting a plurality of PCI cards, such as network cards and sound cards. However, some PCI sockets of the computer motherboard in a computer enclosure may be not used, which causes a waste space of the computer enclosure adjacent to the unused PCI sockets.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a mounting assembly together with a hard disk drive (HDD).

FIG. 2 is an assembled, isometric view of FIG. 1.

FIG. 3 is similar to FIG. 2, but viewed from another perspective.

FIG. 4 shows the mounting assembly together with the HDD mounted to a computer enclosure.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

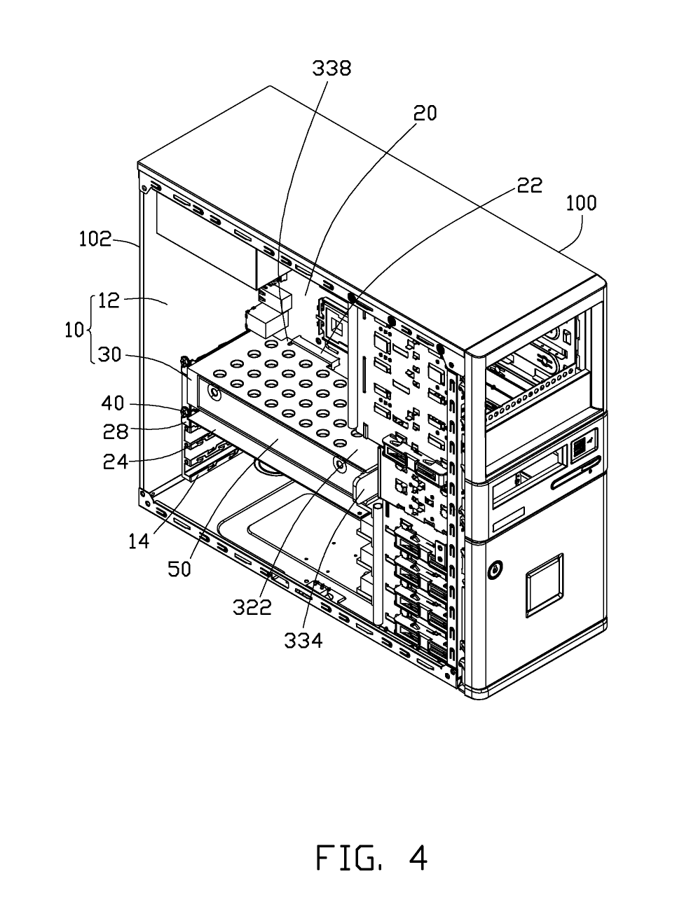

Referring to FIG. 4, an exemplary embodiment of a computer enclosure 10 includes a chassis 12 and a mounting assembly 30. The chassis 12 includes a first sidewall 100, a second sidewall 102 perpendicularly connected to the first sidewall 100, a motherboard 20 mounted to an inner surface of the first sidewall 100, and a fixing member 14 formed on the second sidewall 102. A plurality of peripheral component interconnection (PCI) sockets 22 is formed on the motherboard 20, for electrically connecting a plurality of expansion cards 24. A fixing piece 28 is mounted to an end of each expansion card 24. A screw 40 extends through each fixing piece 28 and then is engaged in the fixing member 14, to fix the corresponding expansion card 24 in the chassis 12.

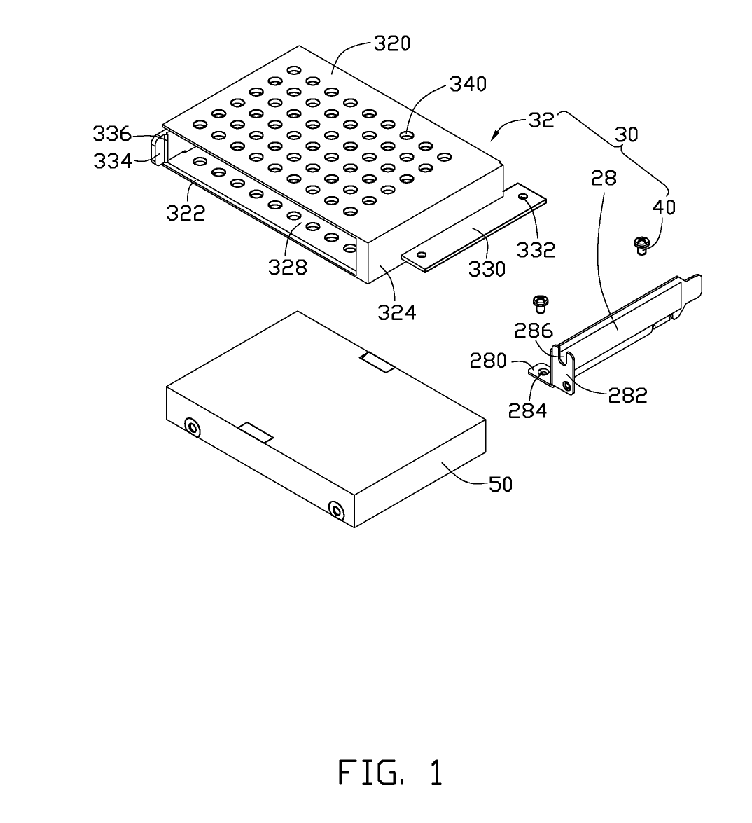

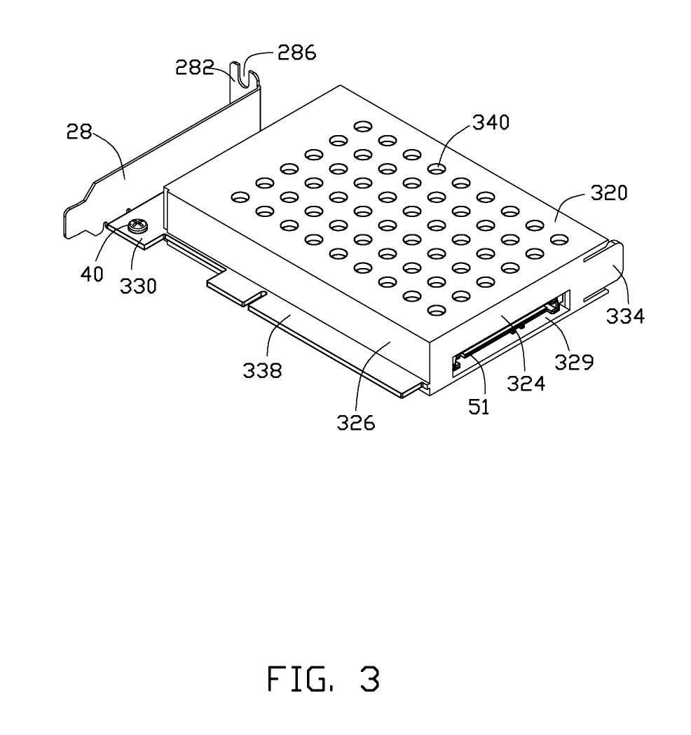

Referring to FIG. 1 and FIG. 3, the mounting assembly 30 is provided for fixing a hard disk drive (HDD) 50 having a connector 51 in the chassis 12 and takes a reserved place which is for mounting an expansion card 24. The mounting assembly 30 includes a fixing piece 28, a casing 32, and a plurality of screws 40. Two tabs 280 perpendicularly extend out from a side of the fixing piece 28. An installing piece 282 perpendicularly extends from an end of the fixing piece 28, extending away from the tabs 280. Each tab 280 defines a through hole 284. The installing piece 282 defines a cutout 286. The casing 32 includes a top wall 320, a bottom wall 322, two end walls 324 perpendicularly connected between corresponding ends of the top and bottom walls 320 and 322, and a rear wall 326 perpendicularly connected between rear sides of the top and bottom walls 320 and 322. The casing 32 defines an opening 328 in a front side of the casing 32 opposite to the rear wall 326. A plate 330 perpendicularly extends out from a lower portion of one of the end walls 324, and defines two through holes 332. A blocking piece 334 extends out from a front end of the other end wall 324 away from the rear wall 326. A groove 329 is defined in the end wall 324 which forms the blocking piece 334. A wedge-shaped projection 336 protrudes from an inner surface of the blocking piece 334. A dummy PCI connector 338 perpendicularly extends out from the rear wall 326. The top and bottom walls 320 and 322 each define a plurality of vents 340 for dissipating heat generated by the HDD 50.

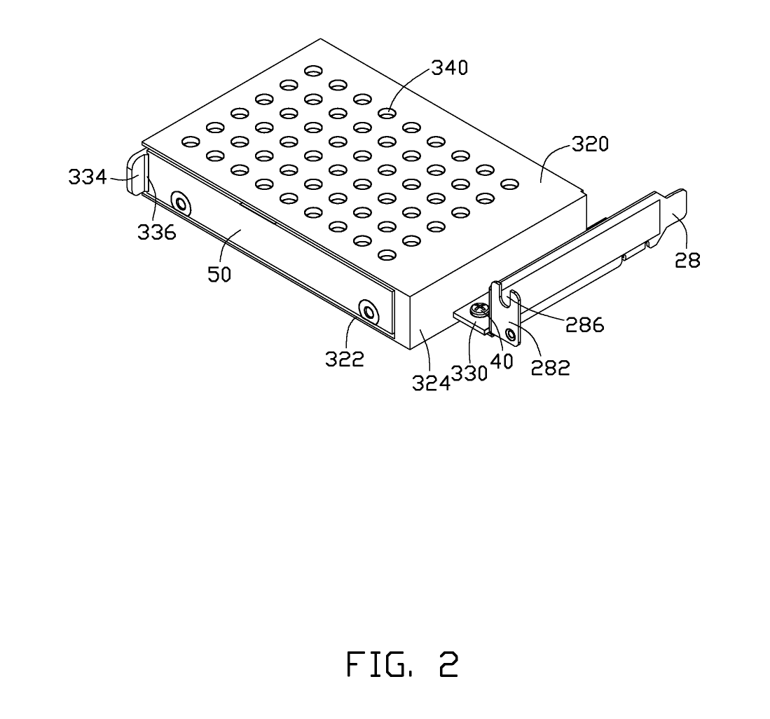

Referring FIGS. 2 and 3, in assembly of the mounting assembly 30, the plate 330 is placed on the tabs 280, two screws 40 extend through the through holes 332 and engage in the corresponding through holes 284, to fix the casing 32 to the fixing piece 28.

In assembling the HDD 50, the HDD 50 is pushed into the casing 32 through the opening 328. The blocking piece 334 is deformed away from the fixing piece 28, until the HDD 50 is completely received in the casing 32. The blocking piece 334 is restored and biases the projection 336 to block an outer surface of the HDD 50 opposite to the rear wall 326, thereby fixing the HDD 50 in the casing 32. The connector 51 is aligned with the groove 329, and capable of being connected to cables or connectors (not shown) outside the casing 32.

Referring to FIG. 4, in installing the mounting assembly 30 and the HDD 50 to the chassis 12, the dummy connector 338 is inserted into a reserved PCI socket 22. The fixing piece 28 contacts the fixing member 14, and the installing piece 282 is abutted against an end of the fixing member 14 away from the motherboard 20. A screw 40 extends through the cutout 286 and then is engaged in the fixing member 14, to fix the mounting assembly 30 to the chassis 12.

In uninstalling the mounting assembly 30, the screw 40 fixing the mounting assembly 30 to the fixing member 14 is released, and the mounting assembly 30 is pulled away from the motherboard 20 to disengage the dummy connector 338 from the PCI socket 22. The blocking piece 334 is then deformed away from the fixing piece 28, to disengage the projection 336 from the HDD 50; thereby the HDD 50 is readily taken out of the casing 32.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A mounting assembly for a data storage device, comprising:
a fixing piece to be mounted to a sidewall of a chassis; and
a casing for receiving the data storage device, the casing comprising a top wall, a bottom wall, two end walls connected between corresponding ends of the top and bottom walls, and a rear wall connected between rear sides of the top and bottom walls, the casing defining an opening in a front side of the casing opposite to the rear wall, through which the storage device enters the casing;
wherein one of the end walls of the casing is fixed to the fixing piece, a blocking piece extends out from the other end wall, a projection protrudes from an inner surface of the blocking piece to block an outer side of the storage device opposite to the rear wall.

2. The mounting assembly of claim 1, wherein the top and bottom walls of the casing each define a plurality of vents for dissipating heat generated by the data storage device.

3. The mounting assembly of claim 1, wherein a dummy connector extends out from the rear wall of the casing.

4. The mounting assembly of claim 1 wherein an installing piece perpendicularly extends from an end of the fixing piece to be fixed to the chassis.

5. The mounting assembly of claim 4, wherein at least one tab extends from the fixing piece away from the installing piece, a plate extends from the end wall of the casing opposite to the blocking piece to be fixed to the at least one tab, to fix the fixing piece to the casing.

6. A computer enclosure, comprising:
a chassis comprising a first sidewall forming a plurality of fixing members for mounting a plurality of expansion cards, and a second sidewall connected to the first sidewall;
a motherboard mounted to an inner surface of the second sidewall, and comprising a plurality of peripheral component interconnection (PCI) sockets;
a data storage device; and
a mounting assembly comprising a casing receiving the data storage device, and a fixing piece fixed to the casing and fixing the casing to the first sidewall, the casing forming a dummy PCI connector mounted to an unused one of the PCI sockets.

7. The computer enclosure of claim 6, wherein the casing comprises a top wall, a bottom wall, two end walls connected between corresponding ends of the top and bottom walls, and a rear wall connected between rear sides of the top and bottom walls, the casing defines an opening in a front side of the casing opposite to the rear wall, through which the storage device enters the casing.

8. The computer enclosure of claim 7, wherein one of the end walls of the casing is fixed to the fixing piece, a blocking piece extends out from the other end wall, and a projection protrudes from an inner surface of the blocking piece to block an outer side of the data storage device opposite to the rear wall.

9. The computer enclosure of claim 8, wherein an installing piece perpendicularly extends from an end of the fixing piece, a screw extends through the installing piece and engages in the fixing member, to fix the fixing piece to the chassis.

10. The computer enclosure of claim 9, wherein at least one tab extends from the fixing piece away from the installing piece, a plate extends from the end wall of the casing opposite to the blocking piece to be fixed to the at least one tab, to fix the fixing piece to the casing.

11. The computer enclosure of claim 7, wherein the dummy PCI connector extends from the rear wall of the casing.

12. The computer enclosure of claim 7, wherein the top and bottom walls each define a plurality of vents for dissipating heat generated by the data storage device.
